(19) United States
(12) Patent Application Publication
(10) Pub. No.: US 2025/0228254 A1
(43) Pub. Date: Jul. 17, 2025

(54) SYNERGISTIC PESTICIDE COMPOSITIONS

(71) Applicant: Ross Lifescience USA Inc., Lorton, VA (US)

(72) Inventors: Rajendra Kshirsagar, Pune (IN); Pavana Nair, Pune (IN); S. Sridhar, Pune (IN)

(73) Assignee: Ross Lifescience USA Inc., Lorton, VA (US)

(21) Appl. No.: 19/016,879

(22) Filed: Jan. 10, 2025

(30) Foreign Application Priority Data
Jan. 11, 2024 (IN) 202421002210

(51) Int. Cl. A01N 65/28; A01N 25/04; A01N 25/08; A01N 35/02; A01N 65/22; A01P 7/00

(52) U.S. Cl. CPC A01N 65/28; A01N 25/04; A01N 25/08; A01N 35/02; A01N 65/22; A01P 7/00

(57) ABSTRACT

The present disclosure provides pesticide compositions and formulations for controlling indoor and outdoor pests comprising Pimenta dioica, Pogostemon cablin, Citral, Cinnamaldehyde, and excipient(s). Also, provided are methods for controlling indoor and outdoor pests. The ingredients of the compositions and formulations of the present disclosure exhibit functional reciprocity therebetween, and aid in effective repelling, killing, preventing, and/or reducing the population of indoor as well as outdoor pests.

### FIELD OF THE INVENTION

The present disclosure relates generally to the field of pesticide composition. In particular, the present disclosure provides compositions and formulations for controlling various indoor and outdoor pests. Also provided is a method for controlling indoor and outdoor pests.

### BACKGROUND

The most numerous and successful animals on earth are undoubtedly insects. Despite some helpful species, many insects are a bane to humans. Many months of the year, people venturing outdoors are plagued by biting insects, such as mosquitoes, gnats, noseeums (biting midges), flies, ticks, head lice, fire ants, fleas, and other insects. The bites and stings inflicted by “biting” insects are often itchy, can become infected, and may prove fatal to the subject.

Almost everyone has had the unpleasant experience of being bitten by a mosquito. Mosquito bites can cause skin irritation through an allergic reaction to the mosquito's saliva—this is what causes the red bump and itching. They are the vectors responsible for transmitting serious and life-threatening diseases such as malaria, dengue, yellow fever, chikungunya, and lymphatic filariasis.

Numerous devices, agents, compositions, and formulations are already reported in the literature and are commercially available, capable of repelling, killing, or reducing the number of mosquitoes in a premise. However, these devices, agents/formulations still suffer from certain limitations such as being expensive, ineffective, and exhibiting certain side-effects such as irritation, allergy, uneasiness, reduction in oxygen content, etc.

Therefore, it would be desirable to develop new and improved compositions that repel, kill, prevent, reduce, and control various indoor and outdoor pests, and overcome one or more problems associated with the conventional compositions/formulations thereof.

### OBJECTS

A primary object of the present disclosure is to provide a pesticide composition that overcomes one or more limitations associated with conventional pesticide compositions/formulations.

Another object of the present disclosure is to provide a pesticide composition for repelling and/or reducing and/or controlling various indoor and outdoor pests.

Another object of the present disclosure is to provide a pesticide composition for repelling and/or reducing and/or controlling the population of mosquitoes.

Another object of the present disclosure is to provide a pesticide composition that exhibits high repellence and pesticidal activity.

Another object of the present disclosure is to provide a pesticide composition that is safe and devoid of side effects such as irritation, allergy, uneasiness, reduction in oxygen content, etc.

Another object of the present disclosure is to provide a pesticide composition that exhibits superior storage stability and synergistic activity/functional reciprocity.

Another object of the present disclosure is to provide a pesticide composition that is easy to prepare and economical.

Other objects of the present invention will be apparent from the description of the invention herein below.

### SUMMARY

The present disclosure addresses these and other unmet deficiencies inherent in the relevant pesticide arts and overcomes them by providing compositions/formulations that exhibit enhanced efficacy and economic significance.

The present disclosure relates to a pesticide composition. Specifically, the present disclosure relates to a pesticide composition for controlling indoor and outdoor pests, said composition includes: Pimenta dioica in an amount ranging from about 0.1% to about 35% by weight of the composition; Pogostemon cablin in an amount ranging from about 0.1% to about 40% by weight of the composition; Citral in an amount ranging from about 0.1% to about 30.0% by weight of the composition; Cinnamaldehyde in an amount ranging from about 0.1% to about 35% by weight of the composition; and rest is an excipient.

In some embodiments, the excipient is selected from any or a combination of a perfume, a preservative, an adhesive, a smoldering agent, a burning aid, a binder, a filler, a burnable base, a propellant, a solvent, a wetting agent, a solubilizer, a hardening agent, an emulsifier, a diluent, a lubricant, a colouring agent, a lower alcohol, anti-freezing agent, and a neutralization base.

In some embodiments, the composition is formulated into a liquid form, a semi-solid form, a solid form, a gel, or a gaseous form.

The present disclosure further relates to a pesticide formulation for controlling indoor and outdoor pests, said composition includes: Pimenta dioica in an amount ranging from about 0.1% to about 35% by weight of the formulation; Pogostemon cablin in an amount ranging from about 0.1% to about 40% by weight of the formulation; Citral in an amount ranging from about 0.1% to about 30.0% by weight of the formulation; Cinnamaldehyde in an amount ranging from about 0.1% to about 35% by weight of the formulation; and rest is an excipient.

### DETAILED DESCRIPTION

The embodiments herein and the various features and advantageous details thereof are explained more comprehensively with reference to the non-limiting embodiments that are detailed in the following description. Descriptions of well-known components and processing techniques are omitted so as to not unnecessarily obscure the embodiments herein. The examples used herein are intended merely to facilitate an understanding of the ways in which the embodiments herein may be practiced and to further enable those of skill in the art to practice the embodiments herein. Accordingly, the examples should not be construed as limiting the scope of the embodiments herein.

Unless otherwise specified, all terms used in disclosing the invention, including technical and scientific terms, have the meaning as commonly understood by one of the ordinary skills in the art to which this invention belongs. By means of further guidance, term definitions may be included to better appreciate the teaching of the present invention.

As used in the description herein, the meaning of “a,” “an,” and “the” includes plural reference unless the context clearly dictates otherwise. Also, as used in the description herein, the meaning of “in” includes “in” and “on” unless the context clearly dictates otherwise.

As used herein, the terms “comprise”, “comprises”, “comprising”, “include”, “includes”, and “including” are meant to be non-limiting, i.e., other steps and other ingredients that do not affect the end of result can be added. The above terms encompass the terms “consisting of” and “consisting essentially of”.

The terms “weight percent”, “percent by weight”, “% by weight”, and variations thereof, as used herein, refer to the concentration of a substance as the weight of that substance divided by the total weight of the composition and multiplied by 100. It is understood that, as used here, “percent”, “%”, and the like are intended to be synonymous with “weight percent”, etc.

The terms ‘pest’ and ‘insect’ are used synonymously and interchangeably throughout the specification. The terms ‘pest’ or ‘insect’ as used herein refers to any insect or small animal that is harmful or damages crops or livestock or otherwise interferes with the wellbeing of human beings such as spreading disease, causes destruction, or is otherwise a nuisance. The term ‘pest’ includes but is not limited to arthropods such as insects, arachnids, centipedes, mosquitoes, houseflies, drain flies, Vespa spp. (hornet), cockroaches, ants, bedbugs, spiders, mites, aphids, thrips, whiteflies, loopers, worms, beetles, leafrollers, moths, weevils including larvae and eggs thereof, and reptiles such as lizards.

The term ‘mosquito’ or ‘mosquitoes’ as used herein refers to each species of mosquitoes reported in the literature. It includes both male and female mosquitoes. The term further includes them in their different stages of life cycles such as egg, larva, pupa, and adult.

The term ‘controlling’ as used herein refers to repelling, killing, preventing, and/or reducing the population of various indoor and outdoor pest(s) and/or insect(s).

In some embodiments, the numbers expressing quantities of ingredients, properties such as concentration, reaction conditions, and so forth, used to describe and claim certain embodiments of the invention are to be understood as being modified in some instances by the term “about”. Accordingly, in some embodiments, the numerical parameters set forth in the written description are approximations that can vary depending on the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The present disclosure addresses these and other unmet deficiencies inherent in the relevant pesticide arts and overcomes them by providing compositions/formulations that exhibit enhanced efficacy and economic significance.

The present disclosure is on the premise of a surprising discovery that when Pimenta dioica, Pogostemon cablin, Citral, and Cinnamaldehyde are included as part of a pesticide composition in the weight percentages as defined herein, they exhibit exceptional functional reciprocity and synergistic activity, and affords dramatic improvement in controlling the population of various indoor as well as outdoor pests as compared to the individual ingredients and that too at a very low concentration. The observed synergistic effect is unexpected and surprising.

The present disclosure relates to a pesticide composition for controlling indoor and outdoor pests, said composition includes: Pimenta dioica in an amount ranging from about 0.1% to about 35% by weight of the composition; Pogostemon cablin in an amount ranging from about 0.1% to about 40% by weight of the composition; Citral in an amount ranging from about 0.1% to about 30.0% by weight of the composition; Cinnamaldehyde in an amount ranging from about 0.1% to about 35% by weight of the composition; and rest is an excipient.

In some embodiments, Pimenta dioica in an amount ranging from about 0.1% to about 20% by weight of the composition; Pogostemon cablin in an amount ranging from about 0.5% to about 25% by weight of the composition; Citral in an amount ranging from about 0.2% to about 30.0% by weight of the composition; Cinnamaldehyde in an amount ranging from about 0.1% to about 20% by weight of the composition; and rest is an excipient.

In some embodiments, the pesticide composition includes Pimenta dioica in an amount ranging from about 0.3% to about 35% by weight, including 0.5% to 30%, 0.6% to 32%, 0.1% to 30%, 0.2% to 25%, 0.2% to 20%, 0.5% to 30%, 0.5% to 25%, 0.5% to 20%, 1% to 35%, 1.5% to 30%, 2% to 25%, 2.5% to 20%, or 4% to 35%.

In some embodiments, the pesticide composition includes Pogostemon cablin in an amount ranging from about 0.3% to about 40% by weight, including 0.5% to 40%, 0.6% to 35%, 0.1% to 30%, 0.2% to 25%, 0.2% to 20%, 0.5% to 35%, 0.5% to 30%, 0.5% to 25%, 0.5% to 30%, 1% to 40%, 1.5% to 35%, 2% to 30%, 2.5% to 25%, 4% to 40%, or 4% to 35%.

In some embodiments, the pesticide composition includes Citral in an amount ranging from about 0.2% to about 30% by weight, including 0.5% to 30%, 0.6% to 28%, 0.2% to 25%, 0.2% to 23%, 0.2% to 20%, 0.5% to 30%, 0.5% to 28%, 0.5% to 25%, 0.5% to 23%, 0.5% to 20%, 1% to 30%, 1.5% to 28%, 2% to 25%, 2.5% to 20%, or 4% to 30%.

In some embodiments, the pesticide composition includes Cinnamaldehyde in an amount ranging from about 0.2% to about 35% by weight, including 0.5% to 30%, 0.6% to 32%, 0.2% to 30%, 0.2% to 25%, 0.2% to 20%, 0.5% to 30%, 0.5% to 25%, 0.5% to 20%, 1% to 35%, 1.5% to 30%, 2% to 25%, 2.5% to 20%, or 4% to 35%.

In some embodiments, the composition comprises a whole of or a part of or an extract of or an oil of Pimenta dioica. In some embodiments, the composition comprises roots, leaves, shoots, fruits, husks, seeds, stems, bark sap or bud, inflorescence, or a combination thereof of Pimenta dioica. In some embodiments, the composition comprises leaves, stems, fruits, roots, inflorescence, or a combination thereof of Pimenta dioica. In some embodiments, Pimenta dioica herb is of natural origin grown in natural conditions or a genetically modified variety of Pimenta dioica exhibiting properties such as but not limited to enriched mosquito spatial repellence, indoor acclimatization (can grow and survive in an indoor environment), heights of around 3 feet, and the likes or combination thereof. In some embodiments, Pimenta dioica is a herb produced from techniques such as tissue culturing, or horticultural practices like layering, grafting, stem cutting, etc. having attributes like less water requirements and faster growth. In some embodiments, the composition comprises berry oil of Pimenta dioica.

In some embodiments, the composition comprises a whole of or a part of or an extract of or an oil of Pogostemon cablin. In some embodiments, the composition comprises roots, leaves, twigs, flowers, seeds, or a combination thereof of Pogostemon cablin. In some embodiments, the composition comprises leaves or twigs of Pogostemon cablin. In some embodiments, the composition comprises an oil of Pogostemon cablin. In some embodiments, the composition comprises leaf oil of Pogostemon cablin.

In some embodiments, the composition of the present disclosure aids in repelling, killing, preventing, and/or reducing various indoor and outdoor pests.

In some embodiments, the indoor and outdoor pests are selected from the group consisting of arthropods such as insects, arachnids, centipedes, mosquitoes, houseflies, drain flies, Vespa spp. (Hornet), cockroaches, ants, bedbugs, spiders, mites, aphids, thrips, whiteflies, loopers, worms, beetles, leafrollers, moths, and weevils including larvae, and eggs thereof.

In some embodiments, the excipient is selected from any or a combination of a perfume, a preservative, an adhesive, a smoldering agent, a burning aid, a binder, a filler, a burnable base, a propellant, a solvent, a wetting agent, a solubilizer, a hardening agent, an emulsifier, a diluent, a lubricant, a colouring agent, a lower alcohol, anti-freezing agent, and a neutralization base.

Exemplary perfume(s)/fragrance agent(s) include, without limitation, various naturally or commercially available orange oil, lemon oil, lavender oil, peppermint oil, eucalyptus oil, citronella oil, lime oil, yuzu oil, jasmine oil, cypress oil, green tea essential oil, limonene, α-pinene, linalool, geraniol, phenylethyl alcohol, amylcinnamic aldehyde, cuminaldehyde, benzyl acetate, Pure Soul MMN37683, Classic Guggul MMN37681, Lemony perfume, and the like, or one or more combinations thereof. However, a person skilled in the art would appreciate that any other perfume(s)/fragrance agent(s) can be utilized to serve the intended purpose.

Exemplary preservative(s) include, without limitation, sodium benzoate, potassium sorbate, phenoxyethanol, p-hydroxybenzoic acid esters, sorbic acid, benzoic acid, propionic acid or salts, Butylated Hydroxytoluene (BHT), and the like, or one or more combinations thereof. However, a person skilled in the art would appreciate that any other preservative(s) can be utilized to serve the intended purpose.

Exemplary adhesive(s) include, without limitation, Joss (Jiggit powder), corn starch, wheat starch, potato starch, pea starch, Tamarind starch, and the like, or one or more combinations thereof. However, a person skilled in the art would appreciate that any other adhesive(s) can be utilized to serve the intended purpose.

Exemplary smoldering agent(s) or burning aid(s) include, without limitation, potassium nitrate (KNO₃), sodium nitrate (NaNO₃), potassium chloride, and the like, or one or more combinations thereof. However, a person skilled in the art would appreciate that any other smoldering agent(s) or burning aid(s) can be utilized to serve the intended purpose.

Exemplary binder(s) include, without limitation, guar gum, xanthan gum, starch, for example, potato starch, maize starch, corn starch, tamarind seed powder, water, povidone, copovidone, kaolin, glue (any commercially available) and the like, or one or more combinations thereof. However, a person skilled in the art would appreciate that any other binder(s) can be utilized to serve the intended purpose.

Exemplary filler(s) or burnable base(s) or thickener(s) include, without limitation, Aerosil 200, Paraffin wax, sawdust powder, Joss (Jiggit powder), coconut shell powder, areca nut shell powder, wood powder, wood chips, wood fiber, wood charcoal, vegetable shell powders (for example, cocoa shell), peanut shell, fibrous waste (for example, rayon waste, cotton waste, waste paper, and mineral fibers), and the like, or one or more combinations thereof. However, a person skilled in the art would appreciate that any other filler(s) can be utilized to serve the intended purpose.

Exemplary propellant(s) include, without limitation, liquefied petroleum gas (LPG), dimethyl ether (DME), nitrogen gas, carbonic acid gas, nitrous oxide, compressed air, and the like, or one or more combinations thereof. However, a person skilled in the art would appreciate that any other propellant(s) can be utilized to serve the intended purpose.

Exemplary solvent(s) include, without limitation, hydrocarbons such as aliphatic hydrocarbon (C₅ to C₂₀ carbon atoms having branched and/or unbranched chains), aromatic hydrocarbon, and alicyclic hydrocarbon, diethyl phthalate, alcohols such as ethanol, isopropanol (isopropyl alcohol) and methanol, esters such as fatty acid ester, vegetable oils, animal oils, and water. Further, among the aliphatic hydrocarbons, a paraffinic hydrocarbon (linear or branched saturated hydrocarbon), inter alia, normal paraffin (n-paraffin) is preferably used. It further includes higher fatty acid esters and alcohols. It further includes D-80, D-100, or a mixture thereof in the required amount. Preferable examples of organic solvents include higher fatty acid esters and alcohols. The higher fatty acid ester preferably has 16 to 20 carbon atoms in total. Examples of such a higher fatty acid ester include isopropyl myristate, butyl myristate, hexyl laurate, isopropyl palmitate, and combinations thereof. However, a person skilled in the art would appreciate that any other solvent(s) can be utilized to serve the intended purpose.

Exemplary wetting agent(s) include, without limitation, 1,2-propylene glycol, glycerol, hyaluronate sodium, and the like, or one or more combinations thereof. However, a person skilled in the art would appreciate that any other wetting agent(s) can be utilized to serve the intended purpose.

Exemplary solubilizer(s) include, without limitation, isomeryl alcohol APEO, PEG-40 PEG-60, polysorbate 20, the Tween 80, and the like, or one or more combinations thereof. However, a person skilled in the art would appreciate that any other solubilizer(s) can be utilized to serve the intended purpose.

Exemplary hardening agent(s) include, without limitation, water-miscible sylvite, sodium salt, magnesium salts, calcium salt, and the like, or one or more combinations thereof. However, a person skilled in the art would appreciate that any other hardening agent(s) can be utilized to serve the intended purpose.

Exemplary emulsifier(s) include, without limitation, hydrogenated lecithin, C12-16 Alcohols, palmitic acid (e.g., Biophillic™ H) and cetyl alcohol, glyceryl stearate, PEG-75 stearate, ceteth-20, steareth-2 (Emulium® Delta), Tween (Tween 20, Tween 40, Tween 60 and Tween 80), Atlas G-50002L-LQ (CQ), Atlox 4913-LQ (MV), and the like, or one or more combinations thereof. However, a person skilled in the art would appreciate that any other emulsifier(s) can be utilized to serve the intended purpose.

Exemplary diluent(s) include, without limitation, microfine cellulose, lactose, starch, pregelatinized starch, calcium carbonate, calcium sulphate, sugar, dextrates, dextrin, dextrose, dibasic calcium phosphate dihydrate, tribasic calcium phosphate, kaolin, magnesium carbonate, magnesium oxide, maltodextrin, mannitol, potassium chloride, powdered cellulose, sodium chloride, sorbitol, talc, silicon oil, and the like, or one or more combinations thereof. However, a person skilled in the art would appreciate that any other diluent(s) can be utilized to serve the intended purpose.

Exemplary lubricant(s) include, without limitation, zinc stearate, magnesium stearate, stearic acid, calcium stearate, Vegetable stearin, and the like, or one or more combinations thereof. However, a person skilled in the art would appreciate that any other lubricant(s) can be utilized to serve the intended purpose.

Exemplary colouring agent(s) include, without limitation, E102 Tartrazine, E104 Quin-oline Yellow, E110 Sunset Yellow FCF, E120—Cochineal, carminic acid, Carmines, E122 Azorubine (Carmoisine), E123 Amaranth, E124 Ponceau 4R (Cochineal Red A), E127 Erythrosine, E129 Allura Red, E131 Patent Blue, and the like, or one or more combinations thereof. However, a person skilled in the art would appreciate that any other colouring agent(s) can be utilized to serve the intended purpose.

Exemplary lower alcohol(s) include, without limitation, ethanol, ethylene glycol, propane diols, glycerin, butanediol, and the like, or one or more combinations thereof. However, a person skilled in the art would appreciate that any other lower alcohol(s) can be utilized to serve the intended purpose.

Exemplary anti-freezing agent(s) include, without limitation, ethylene glycol, propane diols, glycerine or the urea, glycol (mono ethylene glycol, diethylene glycol, polypropylene glycol, Propylene glycol, polyethylene glycol), glycerine, urea, magnesium sulfate heptahydrate, sodium chloride and the like, or one or more combinations thereof. However, a person skilled in the art would appreciate that any other-freezing agent(s) can be utilized to serve the intended purpose.

Exemplary neutralization base(s) include, without limitation, triethanolamine. However, a person skilled in the art would appreciate that any other neutralization base(s) can be utilized to serve the intended purpose.

While one or more embodiments of the present disclosure enumerates and describes a list of excipients that may be used in the composition to serve an intended purpose, it should be appreciated that one or more excipient(s) may also serve more than one function, obviating the need of inclusion of separate excipients for the specified purpose. Although several embodiments of the present disclosure name a few of the commonly used excipients, any other excipient(s) known to or appreciated by a skilled person can also be used to realize the advantageous compositions of the present disclosure.

In some embodiments, the composition is formulated into a liquid form, a semi-solid form, a solid form, a gel, or a gaseous form.

In some embodiments, composition is formulated into a cream, a lotion, an ointment, a gel, a spray, a vaporizer, a paste, a powder, a dust, a wax, a chalk, granules, pellets, a burning paper, a coil, a stick, a bait, cordages, a candle, a sealing agent, a caulk, a patch, a bait, a mat, a filler, a wood filler, a crack and service filler, self-ignite formulation, a mist, a liquid vaporizer, an aerosol, an emulsion, a suspension, a micro-emulsion, a varnish dispersion, a fumigant, or a solution.

The composition according to the present disclosure is a self-combusting powder, that is, it burns completely without the need for a wick, producing smoke wherein, it has a higher density than air and is heavy. In some embodiments, the powder formulation can be loaded in/on a combustible material rolling over a self-ignitable match stick. The present disclosure also provides a method for applying pesticides, methods for manufacturing the self-combusting powder composition, and the use thereof for pest control wherever required.

In some embodiments, the self-ignite formulations are delivered through various conventional devices, for example, a device that may contain an ignitable material such as potassium nitrate, and the like, that may lead to fire flame after being stroked against a striking surface (made up of materials such as sand, powdered glass, red phosphorus and the like). In some embodiments, in such devices for e.g. a match head is dragged along the striking surface, the sand and powdered glass cause friction and heat, which is enough to convert some of the red phosphorous to white phosphorus, a volatile chemical that immediately ignites upon coming in contact of the air and, hence, act as a source of smoldering for a pesticidal formulation loaded on a wooden splint. Any device, known to or appreciated by a person skilled in the art can be used to deliver the pesticide composition/formulation disclosed in the present disclosure to serve the intended purpose.

The present disclosure further provides a solid pesticide formulation for controlling indoor and outdoor pests said formulation comprises: Pimenta dioica in an amount ranging from about 0.1% to about 35% by weight of the formulation; Pogostemon cablin in an amount ranging from about 0.1% to about 40% by weight of the formulation; Citral in an amount ranging from about 0.1% to about 30.0% by weight of the formulation; Cinnamaldehyde in an amount ranging from about 0.1% to about 35% by weight of the formulation; and rest is an excipient.

In some embodiments, the solid formulation comprises a granule, a paste, a powder, a dust, a wax, a chalk, pellets, a burning paper, a coil, a stick, a bait, cordages, a candle, a sealing agent, a caulk, a patch, a bait, a mat, a filler, a wood filler, a crack and service filler, and a self-ignite formulation.

The present disclosure further provides a liquid or a semisolid pesticide formulation for controlling indoor and outdoor pests said formulation comprises: Pimenta dioica in an amount ranging from about 0.1% to about 35% by weight of the formulation; Pogostemon cablin in an amount ranging from about 0.1% to about 40% by weight of the formulation; Citral in an amount ranging from about 0.1% to about 30.0% by weight of the formulation; Cinnamaldehyde in an amount ranging from about 0.1% to about 35% by weight of the formulation; and rest is an excipient.

In some embodiments, the liquid or a semisolid formulation comprises a cream, a lotion, an ointment, a gel, a spray, a vaporizer, a paste, a mist, a liquid vaporizer, an aerosol, an emulsion, a suspension, a micro-emulsion, a varnish dispersion, a fumigant, or a solution.

The present disclosure further provides a method for controlling indoor and outdoor pests providing a composition in an amount effective to control indoor and outdoor pests, said composition comprises: Pimenta dioica in an amount ranging from about 0.1% to about 35% by weight of the composition; Pogostemon cablin in an amount ranging from about 0.1% to about 40% by weight of the composition; Citral in an amount ranging from about 0.1% to about 30.0% by weight of the composition; Cinnamaldehyde in an amount ranging from about 0.1% to about 35% by weight of the composition; and rest is an excipient.

In some embodiments, the indoor and outdoor pests are selected from the group consisting of arthropods such as insects, arachnids, centipedes, mosquitoes, houseflies, drain flies, Vespa spp. (Hornet), cockroaches, ants, bedbugs, spiders, mites, aphids, thrips, whiteflies, loopers, worms, beetles, leafrollers, moths, and weevils including larvae, and eggs thereof.

Pimenta dioica or Pimenta dioica (L.) Merr. (Allspice) also known as Jamaican pepper or pimento, is a tropical evergreen tree of the myrtle family (Myrtaceae). The plant is native to the West Indies, and Central America and is cultivated in many parts of India. Allspice is so named because the flavor of the dried berry resembles a combination of cloves, cinnamon, and nutmeg. Its berries are the source of a highly aromatic spice.

Pogostemon cablin is a species of flowering plant in the family Lamiaceae, commonly called the mint or deadnettle family. The plant grows as a bushy perennial herb, with erect stems reaching up to 75 centimeters (2.5 ft) in height and bearing small, pale pink-white flowers. It is commonly known as Patchouli. It is native to the island region of Southeast Asia, including Sri Lanka, Indonesia, and the Philippines. It is also found in many parts of North East India.

In accordance with an embodiment, the composition of the present disclosure is realized by using extracts or oils or any plant part thereof commercially procured from the following manufactures:

| Sr. | | |
|---|---|---|
| No. | INGREDIENTS | MANUFACTURER |
| 1 | Pimenta dioica | Katyani Exports, New Delhi, India. |
| | (Common name: | |
| | Allspice) | |
| 2 | Pogostemon cablin | Jl. Raya Wanaherang No. 16, |
| | (Common name: | RT.4/RW.4, Cicadas, Kec. Gn. Putri, |
| | Patchouli) | Kabupaten Bogor, Jawa Barat- 16964, |
| | | Indonesia |
| 3 | Citral | Natures Natural India Oils Pvt. Ltd., |
| | | Ghaziabad, Uttar Pradesh- 201010 |
| 4 | Cinnamaldehyde | Katyani Exports, New Delhi, India. |

The compositions and formulations of the present disclosure can be manufactured by any conventional method, known to or appreciated by a person skilled in the art working in the pertinent field to serve the intended purpose.

The ingredients of the composition of the present disclosure exhibit functional reciprocity therebetween, and accordingly, aid in repelling, killing, preventing, and/or reducing the population of indoor as well as outdoor pests. Compositions/formulations of the present disclosure also exhibit superior storage stability. The composition of the present disclosure also provides a pleasant aroma by releasing different fragrances to give an aromatherapy effect while knocking down harmful pests. The composition/formulations are safe and free of any ill effects such as irritation, allergy, uneasiness, reduction in oxygen content, etc. The composition of the present disclosure also provides a pleasant aroma by releasing different fragrances to give an aromatherapy effect while knocking down harmful pests. The composition is safe and free of ill effects such as irritation, allergy, uneasiness, reduction in oxygen content, etc.

### EXAMPLES

The disclosure will now be illustrated with working examples, which are intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices, and materials are described herein. It is to be understood that this disclosure is not limited to particular methods, and experimental conditions described, as such methods and conditions may vary.

An Aerosol Formulation of Pimenta dioica

TABLE 1
An Aerosol formulation of Pimenta dioica

| Sr. | | Role in | Amount |
|---|---|---|---|
| No. | Ingredients | formulation | in wt. % |
| 1 | Pimenta dioica | Pesticide | 15 |
| | (essential oil) | | |
| 2 | Butylated Hydroxytoluene | Preservative | 1 |
| | (BHT) | | |
| 3 | Lemony Perfume | Fragrance | 2 |
| 4 | LPG | Propellant | 82 |
| | Total | | 100 |

All the ingredients were weighed accurately as per Table 1 above and were properly mixed (except propellant) to obtain a blend in a beaker. The blend was transferred in a commercially available aerosol tin, and a valve was put in the tin followed by its crimping to obtain a crimped tin. The propellant was added into the crimped tin to obtain the aerosol formulation of Pimenta dioica and was used for controlling various indoor and outdoor pests.

An Aerosol Formulation of Pogostemon cablin

TABLE 2
An Aerosol formulation of Pogostemon cablin

| Sr. | | Role in | Amount |
|---|---|---|---|
| No. | Ingredients | formulation | in wt. % |
| 1 | Pogostemon cablin | Pesticide | 15 |
| | (leaf essential oil) | | |
| 2 | Butylated Hydroxytoluene | Preservative | 1 |
| | (BHT) | | |
| 3 | Lemony Perfume | Fragrance | 2 |
| 4 | LPG | Propellant | 82 |
| | Total | | 100 |

All the ingredients were weighed accurately as per Table 2 above and were properly mixed (except propellant) to obtain a blend in a beaker. The blend was transferred in a commercially available aerosol tin, and a valve was put in the tin followed by its crimping to obtain a crimped tin. Above weight, propellant was added into the crimped tin to obtain the aerosol formulation of Pogostemon cablin and was used for controlling various indoor and outdoor pests.

### An Aerosol Formulation of Citral

TABLE 3
An Aerosol formulation of Citral

| Sr. | | Role in | Amount |
|---|---|---|---|
| No. | Ingredients | formulation | in wt. % |
| 1 | Citral | Pesticide | 15 |
| 2 | Butylated Hydroxytoluene | Preservative | 1 |
| | (BHT) | | |
| 3 | Lemony Perfume | Fragrance | 2 |
| 4 | LPG | Propellant | 82 |
| | Total | | 100 |

All the ingredients were weighed accurately as per Table 3 above and were properly mixed (except propellant) to obtain a blend in a beaker. The blend was transferred in a commercially available aerosol tin, and a valve was put in the tin followed by its crimping to obtain a crimped tin. Above weight, propellant was added into the crimped tin to obtain the aerosol formulation of Citral and was used for controlling various indoor and outdoor pests.

### An Aerosol Formulation of Cinnamaldehyde

TABLE 4
An Aerosol formulation of Cinnamaldehyde

| Sr. | | Role in | Amount |
|---|---|---|---|
| No. | Ingredients | formulation | in wt. % |
| 1 | Cinnamaldehyde | Pesticide | 15 |
| 2 | Butylated Hydroxytoluene | Preservative | 1 |
| | (BHT) | | |
| 3 | Lemony Perfume | Fragrance | 2 |
| 4 | LPG | Propellant | 82 |
| | Total | | 100 |

All the ingredients were weighed accurately as per Table 4 above and were properly mixed (except propellant) to obtain a blend in a beaker. The blend was transferred in a commercially available aerosol tin, and a valve was put in the tin followed by its crimping to obtain a crimped tin. Above weight, propellant was added into the crimped tin to obtain the aerosol formulation of Cinnamaldehyde and was used for controlling various indoor and outdoor pests.

An Aerosol Formulation of Pimenta dioica, Pogostemon cablin, Citral and Cinnamaldehyde

TABLE 5
An Aerosol formulation of Pimenta dioica and
Pogostemon cablin, Citral, and Cinnamaldehyde

| | | | Formulation | Formulation | Formulation |
|---|---|---|---|---|---|
| Sr. | | Role in | 1 | 2 | 3 |
| No. | Ingredients | formulation | (amount in wt. %) | | |
| 1 | Pimenta dioica | Pesticide | 1 | 2 | 4 |
| | (Berry essential oil) | | | | |
| 2 | Pogostemon cablin | Pesticide | 1 | 2 | 4 |
| | (Leaf essential oil) | | | | |
| 3 | Citral (Source: | Pesticide | 1 | 2 | 4 |
| | Lemon and Orange) | | | | |
| 4 | Cinnamaldehyde (Source: | Pesticide | 1 | 2 | 4 |
| | Cinnamomum species) | | | | |
| 5 | Butylated Hydroxytoluene | Preservative | 1 | 1 | 1 |
| | (BHT) | | | | |
| 6 | LPG | Propellant | 95 | 91 | 83 |
| | Total | | 100 | 100 | 100 |

All the ingredients were weighed accurately as per Table 5 above and were properly mixed (except propellant) to obtain a blend in a beaker. The blend was transferred into a commercially available aerosol tin, and a valve was put in the tin followed by its crimping to obtain a crimped tin. Above weight propellant was added into the crimped tin to obtain the aerosol formulation of the present disclosure comprising Pimenta dioica, Pogostemon cablin oil, Citral, and Cinnamaldehyde and was used for controlling various indoor and outdoor pests.

### Efficacy Study of the Aerosol Formulation

The aerosol Formulations realized in Table 5 above vis-à-vis the aerosol formulations of the individual active ingredient(s) (Pimenta dioica, Pogostemon cablin, Citral, and Cinnamaldehyde) prepared in Tables 1, 2, 3, 4, and 5 were subjected to efficacy studies, particularly, mosquitocidal activity. The mosquitocidal activity was determined by using a Peet Grady Chamber. The Peet Grady Chamber is a 5.8 m³ chamber having all 5 sides made up of glass with glazy tile flooring. At the bottom left side, there is a small window of 0.5×0.5 ft. for releasing insects in the chamber. Apart from this, it has a door on one wall and four 2-inch diameter holes on each wall placed at a distance of 1.4 m from the ground and in the centre of the wall. These holes are used for dispensing test products inside the chamber. During experimentation, the holes, door, and small window, all were in closed condition. For consistency and reproducibility of results, the environmental conditions viz. temperature of 27±3° C. and Relative Humidity of about 50-80% were maintained. Before evaluating the mosquitocidal activity of Formulation 1 vis-à-vis aerosol formulation of the individual active ingredients, the Culex quinquefasciatus mosquitoes were first introduced into the chamber, and de-contamination checks were performed for the first ½ hour. If no knockdown of mosquito(es) was seen, then a fresh lot (100 nos.) of Culex quinquefasciatus mosquitoes was introduced, and about 2 g of Formulations 1-3, aerosol formulation of the individual active ingredients and a commercially available mosquitocidal aerosol formulation were released in the chamber by spraying, and the experiment was started. The knockdown of insects was observed every 5 minutes for about 60 minutes. Thereafter, the knocked-down mosquitoes were transferred to a clean container with food of 10% sucrose contained in a cotton swab. The mortality readings were noted after 24 hours. Observations were interpreted in Knock-down times, KT₅₀ and KT₉₀ [KT₅₀ is the time (in minutes) needed to knock down 50% of the mosquito population used for an experiment, and KT₉₀ is the time (in minutes) needed to knock down 90% of the mosquito population used for an experiment] and it is determined by the Probit analysis software. Percent mortality was calculated after 24 hours.

TABLE 6
Mosquitocidal activity of aerosol formulations
of the present disclosure vis-a-vis aerosol formulations
of the individual active ingredient(s)

| | | KT₅₀ | KT₉₀ |
|---|---|---|---|
| Sr. | | (in | (in |
| No. | Item | minutes) | minutes) |
| 1 | 15% aerosol formulation of Pimenta | 23 | 44 |
| | dioica (prepared in Table 1 above) | | |
| 2 | 15% aerosol formulation of Pogostemon | 18 | 37 |
| | cablin (prepared in Table 2 above) | | |
| 3 | 15% aerosol formulation of Citral | 45 | 98 |
| | (prepared in Table 3 above) | | |
| 4 | 15% aerosol formulation of | 38 | 74 |
| | Cinnamaldehyde (prepared in Table 4 | | |
| | above) | | |
| 5 | Formulation 1 (prepared in Table 5 above) | 11 | 31 |
| 6 | Formulation 2 (prepared in Table 5 above) | 9 | 19 |
| 7 | Formulation 3 (prepared in Table 5 above) | 8 | 14 |
| 8 | Commercially available synthetic aerosol | 10 | 33 |
| | formulation (0.25% EBT Aerosol) | | |

As can be seen in Table 6 above, the formulations (Formulations 1-3) of the present disclosure afford improved control of mosquitoes (pests) as compared to the formulations of the individual active ingredients, and that too at a very low concentration of each pesticide agent. Accordingly, it could be concluded that the composition/formulation of the present disclosure offers a significant improvement in controlling various indoor and outdoor pests as compared to the compositions/formulations of the individual active ingredient(s) and commercially available pesticide formulation at low concentrations (economical).

A Fogger Formulation of Pimenta dioica, Pogostemon cablin, Citral and Cinnamaldehyde

TABLE 7
A Fogger formulation of Pimenta dioica and
Pogostemon cablin, Citral, and Cinnamaldehyde

| Sr. | | Role in | Amount |
|---|---|---|---|
| No. | Ingredients | formulation | in wt. % |
| 1 | Pimenta dioica | Pesticide | 20 |
| | (Berry essential oil) | | |
| 2 | Pogostemon cablin | Pesticide | 10 |
| | (Leaf essential oil) | | |
| 3 | Citral (Source: Lemon and | Pesticide | 10 |
| | Orange) | | |
| 4 | Cinnamaldehyde (Source: | Pesticide | 10 |
| | Cinnamomum species) | | |
| 5 | LPG | Propellant | 50 |
| | Total | | 100 |

All the ingredients were weighed accurately per Table 7 above and properly mixed (except propellant) to obtain a blend in a beaker. The blend was transferred into a commercially available aerosol tin, and a valve was put in the tin followed by its crimping to obtain a crimped tin. The above-weight propellant was added into the crimped tin to obtain the aerosol formulation of the present disclosure comprising Pimenta dioica, Pogostemon cablin oil, Citral, and Cinnamaldehyde. It was used for controlling various indoor and outdoor pests.

A Stick Formulation of Pimenta dioica, Pogostemon cablin, Citral and Cinnamaldehyde

TABLE 8
A Stick formulation of Pimenta dioica and
Pogostemon cablin, Citral, and Cinnamaldehyde

| Sr. | | Role in | Amount |
|---|---|---|---|
| No. | Ingredients | formulation | in wt. % |
| 1 | Pimenta dioica | Pesticide | 0.20 |
| | (Berry essential oil) | | |
| 2 | Pogostemon cablin | Pesticide | 3.00 |
| | (Leaf essential oil) | | |
| 3 | Citral (Source: Lemon and | Pesticide | 3.00 |
| | Orange) | | |
| 4 | Cinnamaldehyde (Source: | Pesticide | 0.40 |
| | Cinnamomum species) | | |
| 5 | Guar gum | Binder | 2.43 |
| 6 | Jiggit | Adhesive | 9.70 |
| 7 | Sodium Benzoate | Preservative | 0.24 |
| 8 | Potassium nitrate | Smoldering agent | 4.85 |
| 9 | Sawdust powder | Filler | 3.08 |
| 10 | Diethyl phthalate | Solvent | 17.64 |
| 11 | Areca nut shell powder | Filler | 55.46 |
| | Total | | 100.00 |

The above-weighed (Table 8) Guar gum, Jiggit, Sawdust powder, and Areca nut shell powder were taken and mixed properly to obtain a blend and the required amount of water (containing the above-weighed sodium benzoate and potassium nitrate) was added to the blend to obtain a dough. The dough was dried in a desired shape and size to obtain a dried stick. The dried stick was dipped in a solution comprising above weighed amount of Diethyl phthalate, Pimenta dioica, Pogostemon cablin oil, Citral, and Cinnamaldehyde. The final stick obtained was used for controlling various indoor and outdoor pests.

A Chalk Powder Formulation of Pimenta dioica, Pogostemon cablin, Citral and Cinnamaldehyde

TABLE 9
A Chalk powder formulation of Pimenta dioica and
Pogostemon cablin, Citral, and Cinnamaldehyde

| Sr. | | Role in | Amount |
|---|---|---|---|
| No. | Ingredients | formulation | in wt. % |
| 1 | Pimenta dioica (Berry essential oil) | Pesticide | 6.00 |
| 2 | Pogostemon cablin (Leaf essential | Pesticide | 6.00 |
| | oil) | | |
| 3 | Citral (Source: Lemon and Orange) | Pesticide | 3.00 |
| 4 | Cinnamaldehyde (Source: | Pesticide | 3.00 |
| | Cinnamomum species) | | |
| 5 | Tween 20 | Emulsifier | 15.00 |
| 6 | Calcium carbonate | Diluent | 64.00 |
| 7 | Glue | Binder | 3.00 |
| | Total | | 100 |

1

The above-weighed (Table 9) Calcium carbonate and glue were taken and mixed properly to obtain a mixture 1. The above-weighed Pimenta dioica, Pogostemon cablin oil, Citral, and Cinnamaldehyde were taken and added into the emulsifier to obtain mixture 2. Mixture 2 was added into Mixture 1, mixed properly, and poured into a mold to obtain a chalk-shaped structure, which was dried to obtain the final chalk formulation finding its application in controlling various indoor and outdoor pests.

An Emulsifiable Concentrate (EC) Formulation of Pimenta dioica, Pogostemon cablin, Citral and Cinnamaldehyde

TABLE 10
An EC formulation of Pimenta dioica and
Pogostemon cablin, Citral, and Cinnamaldehyde

| Sr. | | Role in | Amount |
|---|---|---|---|
| No. | Ingredients | formulation | in wt. % |
| 1 | Pimenta dioica (Berry essential | Pesticide | 13.00 |
| | oil) | | |
| 2 | Pogostemon cablin (Leaf | Pesticide | 13.00 |
| | essential oil) | | |
| 3 | Citral (Source: Lemon and | Pesticide | 6.00 |
| | Orange) | | |
| 4 | Cinnamaldehyde (Source: | Pesticide | 6.00 |
| | Cinnamomum species) | | |
| 5 | Atlas G-50002L- LQ (CQ) | Emulsifier | 5.00 |
| 6 | Atlox 4913- LQ (MV) | Emulsifier | 15.00 |
| 7 | Silicon oil | Diluent | 0.83 |
| 8 | Butyl Hydroxy Toluene (BHT) | Preservative | 0.08 |
| 9 | Propylene glycol | Anti-freezing | 4.96 |
| | | agent | |
| 10 | Xanthum gum | Binder | 0.25 |
| 11 | Water | Solvent | 35.88 |
| | Total | | 100.00 |

The above-weighed (Table 10) Pimenta dioica, Pogostemon cablin oil, Citral, Cinnamaldehyde, Atlas G, and BHT were taken and mixed properly under stirring for 30 minutes in a vessel to obtain a mixture 1. The above-weighed Atlox, Silicon oil, Propylene glycol, Xanthum gum, and water were taken and mixed properly under stirring for 30 minutes in another vessel to obtain a mixture 2. Mixture 1 was added into mixture 2 slowly under a high shear mixer operating at 8500 RPM and stirred for about 30 minutes to obtain the EC formulation finding its application in controlling various indoor and outdoor pests.

No-Gas Spray Formulation of Pimenta dioica, Pogostemon cablin, Citral and Cinnamaldehyde

TABLE 11
No-gas spray formulation of Pimenta dioica and
Pogostemon cablin, Citral, and Cinnamaldehyde

| Sr. | | Role in | Amount |
|---|---|---|---|
| No. | Ingredients | formulation | in wt. % |
| 1 | Pimenta dioica | Pesticide | 2.00 |
| | (Berry essential oil) | | |
| 2 | Pogostemon cablin | Pesticide | 2.00 |
| | (Leaf essential oil) | | |
| 3 | Citral (Source: Lemon and | Pesticide | 2.00 |
| | Orange) | | |
| 4 | Cinnamaldehyde (Source: | Pesticide | 2.00 |
| | Cinnamomum species) | | |
| 5 | Isopropyl alcohol | Solvent | 92.00 |
| | Total | | 100.00 |

All the ingredients were weighed accurately per Table 11 above and properly mixed to obtain a blend in a beaker. The blend was transferred into a commercially available spray bottle and a valve was put in the spray bottle to obtain the spray formulation of the present disclosure comprising Pimenta dioica, Pogostemon cablin oil, Citral, and Cinnamaldehyde. It was used for controlling various indoor and outdoor pests.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments of the invention have been shown and described, many variations and modifications thereof can be made by one skilled in the art without departing from the spirit and teachings of the invention. Accordingly, the scope of protection is not limited by the description set out above but is only limited by the claims, including all equivalents of the subject matter of the claims. The disclosures of all patents, patent applications, and publications cited herein are hereby incorporated herein by reference, to the extent that they provide procedural or other details consistent with and supplementary to those set forth herein.

### ADVANTAGES

The present disclosure provides pesticide compositions/formulations that overcome the limitations associated with conventional compositions/formulations.

The present disclosure provides pesticide compositions/formulations for repelling and/or reducing and/or controlling various indoor and outdoor pests.

The present disclosure provides pesticide compositions/formulations for repelling and/or reducing and/or controlling the population of mosquitoes.

The present disclosure provides pesticide compositions/formulations that exhibit high repellence and pesticidal activity.

The present disclosure provides pesticide compositions/formulations that are safe and free of side effects such as irritation, allergy, uneasiness, reduction in oxygen content, etc.

The present disclosure provides pesticide compositions/formulations that exhibit synergistic activity/functional reciprocity, economical and easy to prepare.

We claim:

1. A pesticide composition for controlling indoor and outdoor pests, said composition comprises:
Pimenta dioica in an amount ranging from about 0.1% to about 35% by weight of the composition;
Pogostemon cablin in an amount ranging from about 0.1% to about 40% by weight of the composition;
Citral in an amount ranging from about 0.1% to about 30.0% by weight of the composition;
Cinnamaldehyde in an amount ranging from about 0.1% to about 35% by weight of the composition; and
rest is an excipient.

2. The composition as claimed in claim 1, wherein Pimenta dioica is present in an amount ranging from about 0.1% to about 20% by weight of the composition; Pogostemon cablin is present in an amount ranging from about 0.5% to about 25% by weight of the composition; Citral is present in an amount ranging from about 0.2% to about 30.0% by weight of the composition; Cinnamaldehyde is present in an amount ranging from about 0.1% to about 20% by weight of the composition; and rest is an excipient.

3. The composition as claimed in claim 1, wherein the excipient is selected from any or a combination of a perfume, a preservative, an adhesive, a smoldering agent, a burning aid, a binder, a filler, a burnable base, a propellant, a solvent, a wetting agent, a solubilizer, a hardening agent, an emulsifier, a diluent, a lubricant, a colouring agent, a lower alcohol, anti-freezing agent, and a neutralization base.

4. The composition as claimed in claim 1, wherein the composition is formulated into a liquid form, a semi-solid form, a solid form, a gel, or a gaseous form.

5. The composition as claimed in claim 4, wherein the composition is formulated into a cream, a lotion, an ointment, a gel, a spray, a vaporizer, a paste, a powder, a dust, a wax, a chalk, granules, pellets, a burning paper, a coil, a stick, a bait, cordages, a candle, a sealing agent, a caulk, a patch, a bait, a mat, a filler, a wood filler, a crack and service filler, self-ignite formulation, a mist, a liquid vaporizer, an aerosol, an emulsion, a suspension, a micro-emulsion, a varnish dispersion, a fumigant, or a solution.

6. The composition as claimed in claim 1, wherein the indoor and outdoor pests are selected from the group consisting of arachnids, centipedes, mosquitoes, houseflies, drain flies, Vespa spp. (Hornet), cockroaches, ants, bedbugs, spiders, mites, aphids, thrips, whiteflies, loopers, worms, beetles, leafrollers, moths, and weevils including larvae, and eggs thereof.

7. A pesticide formulation for controlling indoor and outdoor pests, said formulation comprises:
Pimenta dioica in an amount ranging from about 0.1% to about 35% by weight of the formulation;
Pogostemon cablin in an amount ranging from about 0.1% to about 40% by weight of the formulation;
Citral in an amount ranging from about 0.1% to about 30.0% by weight of the formulation;
Cinnamaldehyde in an amount ranging from about 0.1% to about 35% by weight of the formulation; and
rest is an excipient.

8. The formulation as claimed in claim 7, wherein the formulation comprises a liquid formulation, a semi-solid formulation, and a solid formulation.

9. The formulation as claimed in claim 8, wherein the solid formulation comprises a granule, a powder, a dust, a wax, a chalk, pellets, a burning paper, a coil, a stick, a bait, cordages, a candle, a sealing agent, a caulk, a patch, a bait, a mat, a filler, a wood filler, a crack and service filler, and a self-ignite formulation, and the liquid or the semi-solid formulation comprises a cream, a lotion, an ointment, a gel, a spray, a vaporizer, a paste, a mist, a liquid vaporizer, an aerosol, an emulsion, a suspension, a micro-emulsion, a varnish dispersion, a fumigant, and a solution.

10. A method for controlling indoor and outdoor pests comprising, providing a pesticide composition comprising:
Pimenta dioica in an amount ranging from about 0.1% to about 35% by weight of the composition;
Pogostemon cablin in an amount ranging from about 0.1% to about 40% by weight of the composition;
Citral in an amount ranging from about 0.1% to about 30.0% by weight of the composition;
Cinnamaldehyde in an amount ranging from about 0.1% to about 35% by weight of the composition; and
rest is an excipient.
